(19) United States
(12) Patent Application Publication
(10) Pub. No.: US 2024/0119090 A1
(43) Pub. Date: Apr. 11, 2024

(54) METHODS AND SYSTEMS FOR AUTOMATED TEMPLATE MINING FOR OBSERVABILITY

(71) Applicants: Ramprasad Gopalsamy, CHENNAI (IN); Sankar Nagarajan, CHENNAI (IN); Shridhar Venkatraman, CAMPBELL, CA (US)

(72) Inventors: Ramprasad Gopalsamy, CHENNAI (IN); Sankar Nagarajan, CHENNAI (IN); Shridhar Venkatraman, CAMPBELL, CA (US)

(21) Appl. No.: 18/221,380

(22) Filed: Jul. 12, 2023

Related U.S. Application Data
(60) Provisional application No. 63/388,927, filed on Jul. 13, 2022.

(51) Int. Cl. G06F 16/81; G06F 9/54

(52) U.S. Cl. CPC G06F 16/81; G06F 9/542; G06F 9/546

(57) ABSTRACT

A method for automated template mining for observability of a plurality of cloud applications and services comprising: collecting a stream of a plurality of semi-structured text messages; defining a structure for a pre-processing each semi-structured text message of the plurality of semi-structured text messages for a defined observability of an event; extracting one or more occurrences of the event from the plurality of semi-structured text messages; grouping a similar event into one or more unique templates; and creating a notification for a similar event when a template of one or more unique templates is detected in the semi-structured text message.

### CLAIM OF PRIORITY

This application claims priority to U.S. Patent Application No. 63/388,927, filed on 13 Jul. 2022 and titled METHODS AND SYSTEMS FOR AUTOMATED TEMPLATE MINING FROM LOGS. This Provisional Patent Application is hereby incorporated by reference in its entirety.

### BACKGROUND

Observability of an application or a service requires extracting insights from different parts of the underlying application environment to understand if there is any change of state that has significance for the management of the application in terms of its availability and performance. Events are typically recognized through notifications created by some monitoring tool that collects data both arriving into the application or within components of the application. The event data are typically captured in multiple streams that are temporally ordered and contain semi-structured messages which means there are tagged elements in the message although entries in the elements have unstructured text and may not have defined limits.

To meet application observability needs, one needs to detect if there is an event that is of significance to availability and performance. This would include detecting if there were a failure or anomaly condition, a change in configuration in the components, or change in the requests or traffic flow into the application. Typically, detecting such events of interest or tagging requires pattern mining on the text in the event streams using parsing of regular expressions. These regular expressions are usually designed and maintained manually by developers. However, such manual approaches have severe limitations when monitoring modern microservice applications for the following reasons, inter alia:
First, the volume of event streams is increasing rapidly, which makes manual methods significantly harder and management of the event detection more complex and cost-prohibitive;
Second tag patterns in modern systems update frequently; and
Third, manually extracting and maintaining tag patterns is tedious, error-prone, and costly.

For purposes of illustration, we will consider URL mining in the rest of the document given it is the most commonly used form of requests into web applications. A URL (Uniform Resource Locator) is a well-known example of a transaction event. A URL consists of multiple pieces of information some of which are strongly defined while others are left to the user. To monitor or secure these events they need to be filtered and grouped. Tag mining from URL streams will be used for explaining the current method in this application.

### SUMMARY OF THE INVENTION

A method for automated template mining for observability of a plurality of cloud applications and services comprising: collecting a stream of a plurality of semi-structured text messages; defining a structure for a pre-processing each semi-structured text message of the plurality of semi-structured text messages for a defined observability of an event; extracting one or more occurrences of the event from the plurality of semi-structured text messages; grouping a similar event into one or more unique templates; and creating a notification for a similar event when a template of one or more unique templates is detected in the semi-structured text message.

### BRIEF DESCRIPTION OF THE DRAWINGS

FIG. 1 illustrates an example process for pattern mining from unstructured system and/or application logs, according to some embodiments.

FIG. 2 illustrates an example process for automated template mining from log messages, according to some embodiments.

FIG. 3 illustrates an example system for pattern mining from unstructured system and/or application logs, according to some embodiments.

FIG. 4 illustrates a process for associating URL information with log identifiers, according to some embodiments.

FIG. 5 illustrates another process for URL template mining, according to some embodiments.

FIG. 6 illustrates an example of raw log messages in a system file with URL information, according to some embodiments.

FIG. 7 illustrates an example of Unique URLs mined from a log file, according to some embodiments.

The Figures described above are a representative set and are not exhaustive with respect to embodying the invention.

### DESCRIPTION

Disclosed are a system, method, and article of manufacture for automated template mining for observability. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application programming interface (API) can specify how software components of various systems interact with each other.

Cloud computing can involve deploying groups of remote servers and/or software networks that allow centralized data storage and online access to computer services or resources. These groups of remote services and/or software networks can be a collection of remote computing services.

Semi-structured text message are text data that has unstructured or free form text but also some predefined structure with known tags or fields.

Streaming log parser such as Drain3 (or Spell or Spray) can be used to extract templates (clusters) from a stream of log messages in a timely manner. For purposes of illustration, we will refer to Drain 3 in this specification. However, other similar log parsers are equally applicable. Drain3 can utilize a parse tree with fixed depth to guide the log group search process (e.g., avoid constructing a deep and/or unbalanced tree). It is noted that in some embodiments, other log template miners can be utilized in lieu of Drain3.

Regular expression can be a sequence of characters that specifies a search pattern in text.

Uniform Resource Locator (URL) is a reference to a web resource that specifies its location on a computer network and a mechanism for retrieving it.

Exemplary Methods and Systems

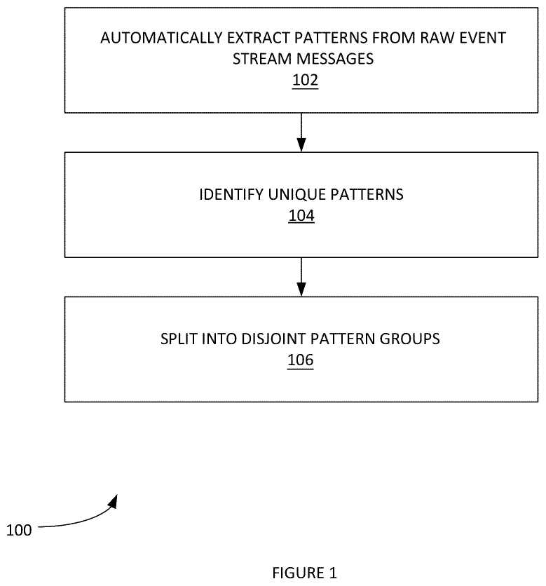

FIG. 1 illustrates an example process 100 for pattern mining from unstructured system and/or application logs, according to some embodiments. Process 100 can be used for automated template mining for observability. Process 100 can accurately and efficiently parse raw event stream messages and identify unique patterns as a template automatically. In step 102, process 100 automatically extracts patterns from raw event stream messages. In step 104, process 100 identifies unique patterns. In step 106, process 100 splits them into disjoint pattern groups. Process 100 can employ a parse tree algorithm with fixed tree depth to effectively guide the pattern group search process.

In one example, given in the body of detecting a specific URL, such as a URL that indicates a “purchase transaction” of an item in an e-commerce site. All URLs that relate to a purchase of any item in the catalog would be similar and could be grouped as “purchase” URL.

Observability events are those that indicate an occurrence of an incident of interest that affects availability or change in performance. These would include an event that indicates the arrival of a new transaction or flow, an anomaly or a failure event, or a change in the system.

It is noted that the detected event can include an anomaly defined by a specific condition in one or more fields in the semi-structured text message. For example, if a log message provides a specific error condition such as a specific HTTP error such as 503 Service Unavailable which would indicate that the requested service being monitored is down.

In one example, a pattern match can be extracting one or more occurrences of the event from the plurality of semi-structured text messages and grouping a similar event into one or more unique templates.

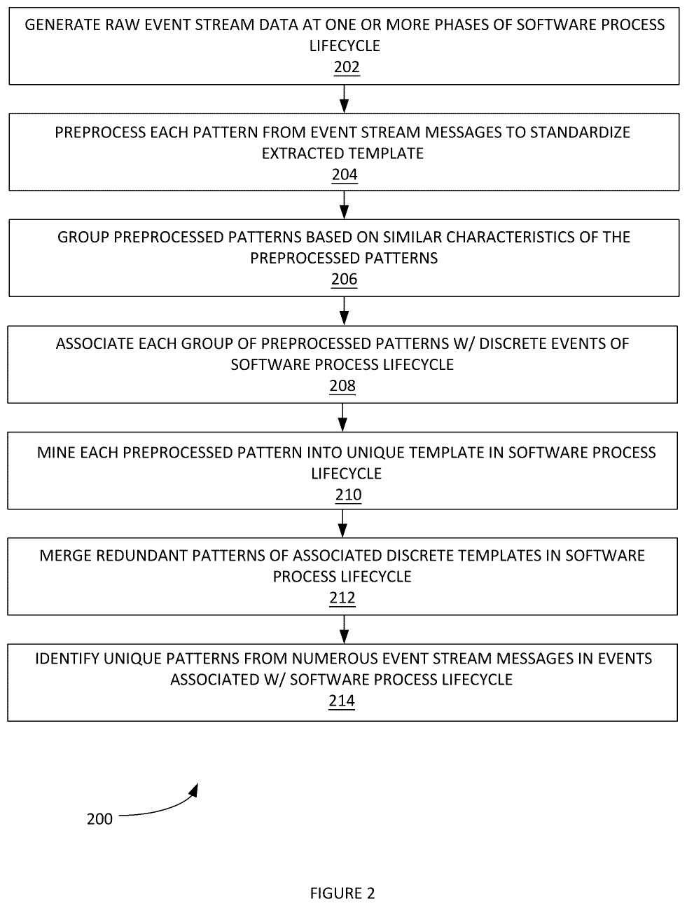

FIG. 2 illustrates an example process 200 for automated software template mining from event stream messages, according to some embodiments. In step 202, process 200 generates raw event stream data at one or more phases of a software process lifecycle. In step 204, process 200 preprocesses each pattern from event stream messages to standardize the extracted template. In step 206, process 200 groups the preprocessed patterns based on similar characteristics of the preprocessed patterns. In step 208, process 200 associates each group of preprocessed patterns with one or more discrete events of the software process lifecycle. In step 210, process 200 mines each preprocessed pattern into a unique template in the software process lifecycle. In step 212, process 200 merges redundant patterns of associated discrete templates in the software process lifecycle. In step 214, process 200 identifies one or more unique patterns from numerous event stream messages in the events associated with the software process lifecycle. The automatically mined unique patterns are meant for the purpose of downstream rules processing or causal inference in the system.

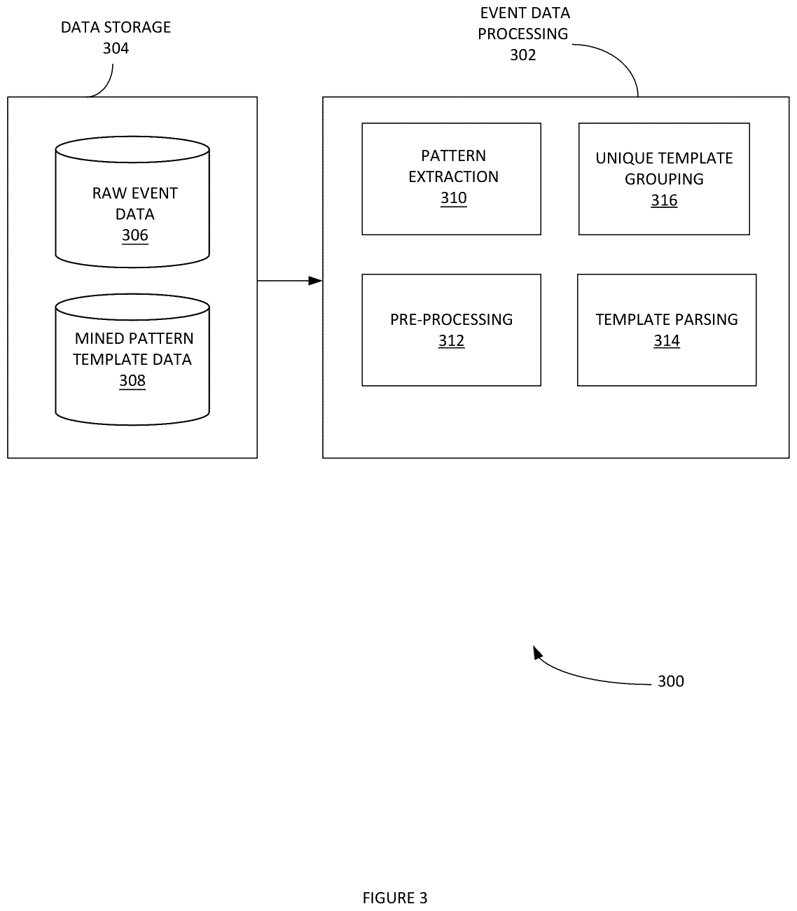

FIG. 3 illustrates an example of automated pattern template mining computing entity 300, according to some embodiments. Pattern template mining computing entity 300 simplifies accurate information retrieval and eliminates the event management complexity by reducing data volumes and thereby reducing the cardinality of the retrieved information. This is expected to reduce the data retention and infrastructure costs, save the complex and redundant manual parsing and/or scripting efforts while at the same time retrieving the unique information. The pattern mining method from event data applies data mining methods to get insights of system behaviors, for service management including for efficient rules processing, causal analysis, and fault diagnosis.

Pattern template mining computing entity 300 includes pattern extraction module 310, unique template grouping module 316, pre-processing module 312, template parsing module 314. Pattern extraction module 310 extract patterns (e.g. URLs, etc.). Pre-processing module 312 then prepares the extracted patterns to template parsing by template parsing module 314. Unique template grouping module 316 groups based on output of template parsing module 314. These can be a part of event data processing 302.

Data Storage 304 can include raw event data 306 and mined pattern template data 308.

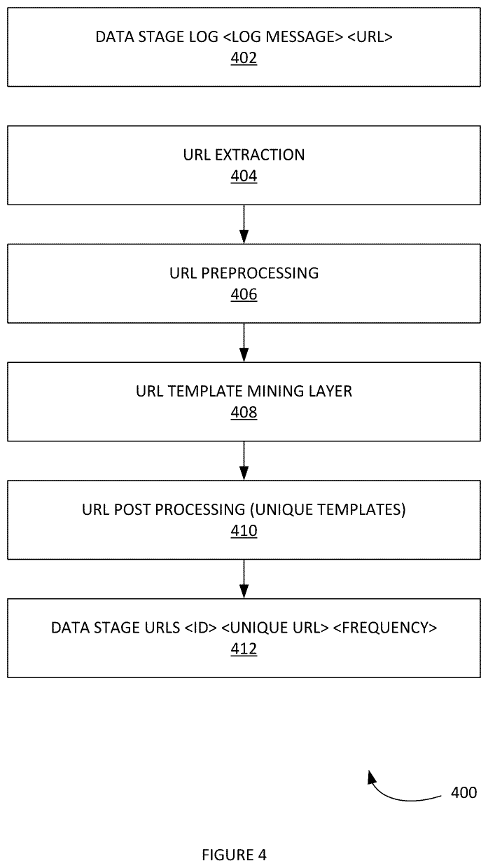

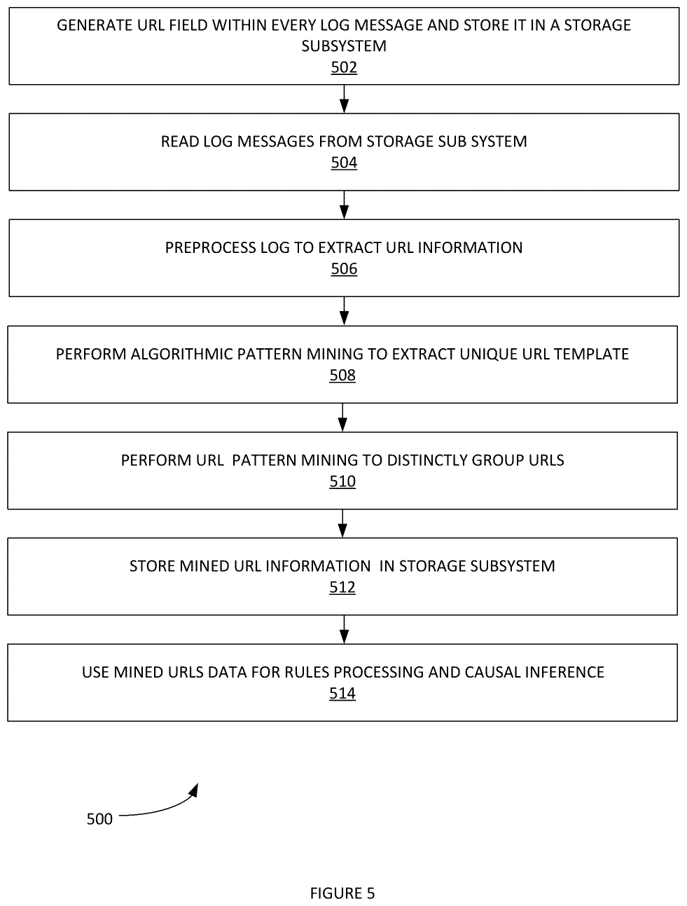

FIG. 4 illustrates another process 400 for associating URL information with log identifiers, according to some embodiments. Process 400 associates each URL information with one or more log file identifiers in the system. This can be done as a unique string pattern, a retrieval data source identifier, and a target data source identifier after the data processing.

Process 400 can obtain data stage log (<log message><URL>) in step 402. This can be obtained from data storage 304.

Process 400 can implement URL extraction from logs in step 404. It is noted that the log messages and the URL data patterns can be unstructured because of the various structural patterns in log messages and identifiers present in the URL patterns. URLs are retrieved from each raw log message. When a new URL message retrieved from a log message arrives it can be preprocessed by applying regular expression masks based on domain knowledge.

Process 400 can implement URL preprocessing in step 406. Process 400 can preprocess the URL data after extracting the raw URL information (e.g., obtained from raw log data 306, etc.) from the log message read from the files stored in a storage subsystem (e.g. data storage 304). When a new raw URL message is retrieved from the file, it can be preprocessed by a defined mask configured as regular expressions based on domain knowledge in the software process.

Process 400 can implement URL template mining in step 408. In one example, the template mining algorithm can use the Drain3 software framework. This framework can utilize the drain parser algorithm and tokenizes the URL text by parsing. This framework can start from the root node of the parse tree with the preprocessed URL message.

Drain3 can apply a fixed depth tree parsing method. The first layer nodes in the parse tree represent URL groups whose URLs are of different URL message lengths. The Drain3 algorithm traverses from a first layer node to a leaf node. Then it selects the next internal node by the tokens in the beginning positions of the URL message. Then the similarity between URL message and URL event of each URL group is calculated to decide whether to insert the URL message into the existing URL group. The parsed tree structure is updated by scanning the tokens in the same position of the URL, finally a search for a URL group is done which is a leaf node of the tree by following the rules encoded in the internal nodes of the tree. If a suitable URL group is found, the retrieved URL can be matched with the URL stored in that URL group. Otherwise, a new URL group can be created based on a retrieved URL. Thus, using template mining, URL information from unstructured log messages is transformed and grouped into uniquely identifiable and structured template data along with their frequency of occurrence.

The final mined data reduces the cardinality of the retrieved URL information by automatically identifying similar patterns and thereby eliminating a lot of redundant URLs in the log data. The URL template mining method is not limited by the memory of a single computer, because the URL messages are retrieved from log files and processed one by one in sequence.

Process 400 can implement URL post-processing in step 410. Process 400 can organize the mined URLs into specific files and are then directed to the storage subsystem as mined URL template data for the purpose of downstream rules generation and causal inference activities. Process 400 can provide data stage URLs <ID><unique URL><frequency> in step 412.

FIG. 5 illustrates another process 500 for URL template mining, according to some embodiments. Process 500 can generate a URL field within every log message and store it in a storage subsystem in step 502. Process 500 can read log messages from the storage subsystem in step 504. Process 500 can preprocess log to extract URL information in step 506. Process 500 can perform algorithmic pattern mining to extract a unique URL template in step 508. Process 500 can perform URL pattern mining to distinctly group URLs in step 510. Process 500 can store mined URL information in the storage subsystem in step 512. Process 500 can use mined URLs data for rules processing and causal inference in step 514.

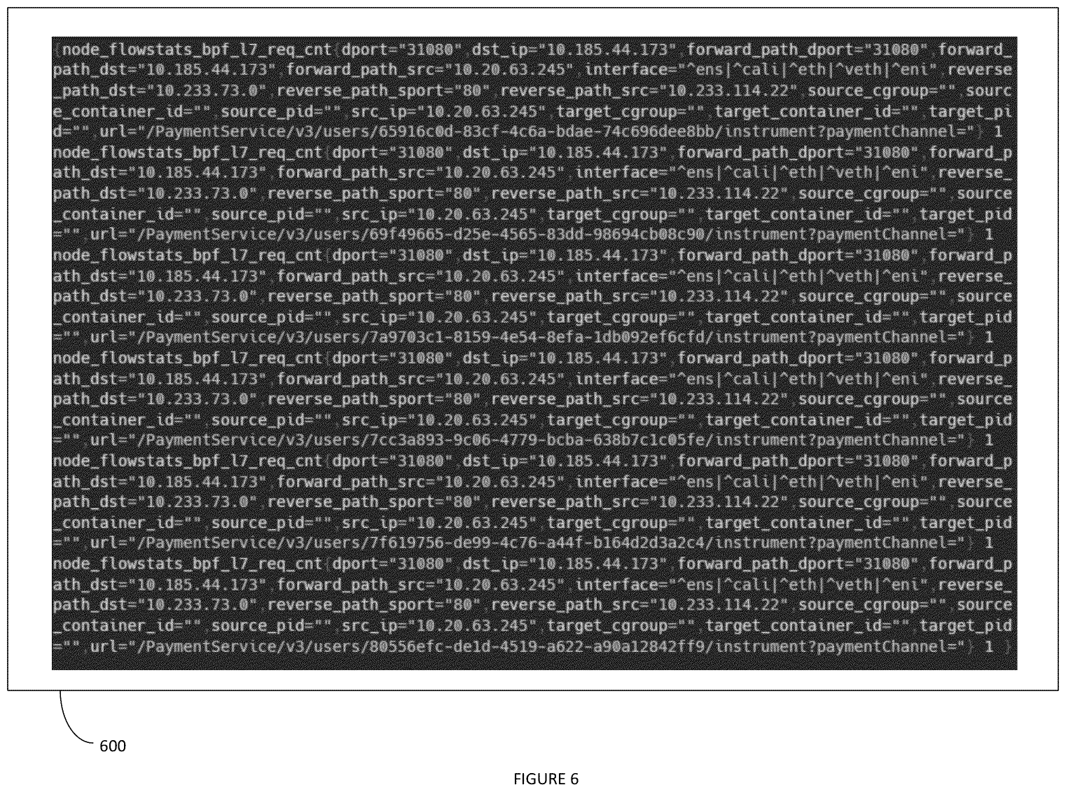

FIG. 6 illustrates an example of raw log messages in a system file with URL information, according to some embodiments.

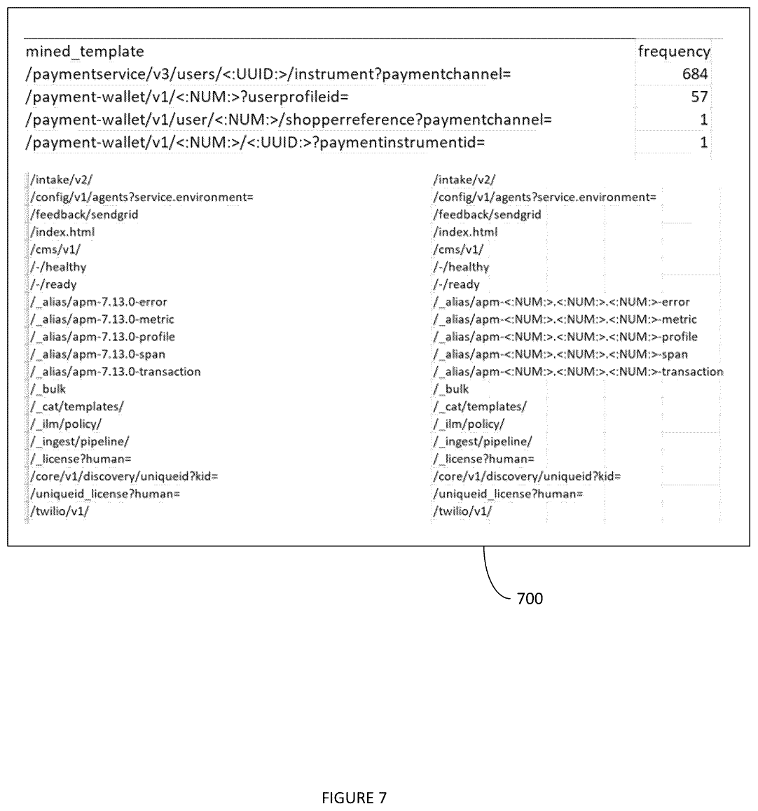

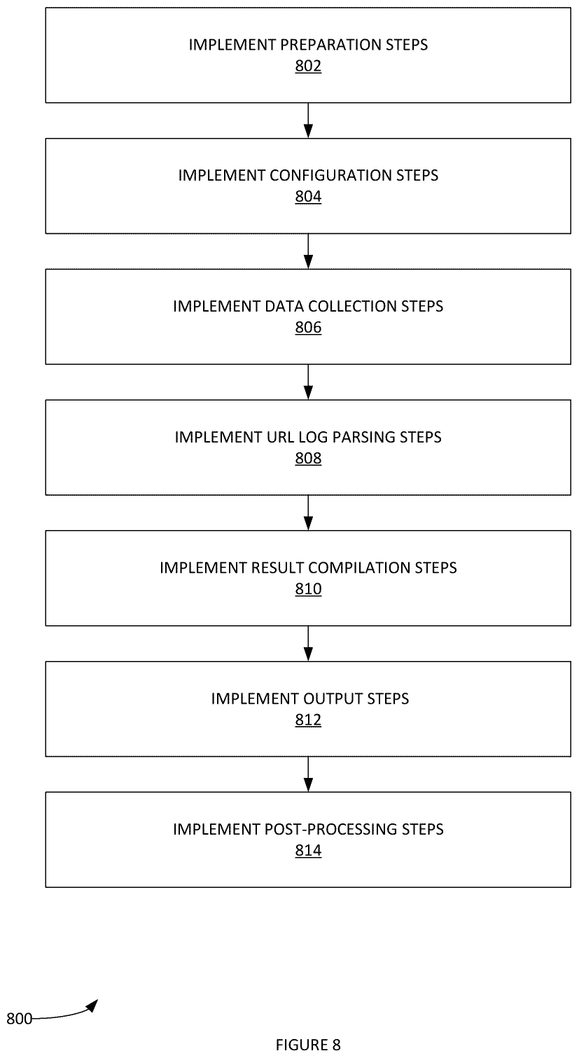

FIG. 7 illustrates an example of Unique URLs mined from a log file, according to some embodiments.

FIG. 8 illustrates an example process 800 for Automated URL Template Mining from logs, according to some embodiments. In one example, process 800 can use automated URL Template Mining from logs using Drain3 was written as a Python program. In step 802, process 800 can implement preparation steps. Process 800 begins by setting up the necessary libraries and configurations. Process 800 also removes any existing log and persistence files to ensure a clean start for each run.

In step 804, process 800 implements configuration steps. Process 800 can configure the Drain3 Template miner with a specific configuration file. The configuration includes various parameters that control the behavior of the log parsing process. It is noted that while other approaches may require manually providing feedback to machine learning based template detection that are not scalable due to high cardinality, predefining the configuration for the tag avoids this disadvantage, besides able to define the explainable explicit events.

In step 806, process 800 implements data collection steps. For example, process 800 can then traverse a directory structure containing log files. Process 800 reads each file line by line, specifically looking for lines containing URLs. These URLs are extracted, cleaned, and stored in a Data Frame for further processing.

In step 808, process 800 implements URL log parsing steps. Process 800 can feed the collected URLs to the Drain3 Template miner. The Template miner processes each URL and attempts to identify a log template that matches the URL. If a match is found, the URL is associated with the corresponding template. If no match is found, a new template is created.

In step 810, process 800 implements result compilation steps. Process 800 can collect the results of the log parsing process, including the input URL and the identified log template. It also keeps track of the frequency of each template. These results are stored in a Data Frame.

In step 812, process 800 implements output steps. Process 800 writes the results to CSV files. It produces several output files, including a file containing the extracted URLs, a file containing the results of the log parsing process, and a file containing the frequency of each identified log template.

In step 814, process 800 implements post-processing steps. Process 800 can perform additional processing on the results to consolidate the data and filter out unique patterns. Process 800 also writes these processed results to CSV files.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by this United States patent:

1. A method for automated template mining for observability of a plurality of cloud applications and services comprising:
collecting a stream of a plurality of semi-structured text messages;
defining a structure for a pre-processing each semi-structured text message of the plurality of semi-structured text messages for a defined observability of an event;
extracting one or more occurrences of the event from the plurality of semi-structured text messages;
grouping a similar event into one or more unique templates; and
creating a notification for a similar event when a template of one or more unique templates is detected in the semi-structured text message.

2. The method of claim 1, wherein the automated template mining for observability of cloud applications and services is updated periodically.

3. The method of claim 1, wherein the automated template mining for observability of cloud applications and services is performed on demand by running a process to find a new pattern and the template from the semi-structured text message.

4. The method of claim 1, wherein the semi-structured text message comprises a log message.

5. The method of claim 1, wherein the semi-structured text message comprises a business flow.

6. The method of claim 1, wherein the semi-structured text message comprises a transaction trace.

7. The method of claim 1, wherein the semi-structured text message comprises a notification from a messaging application.

8. The method of claim 1, where the detected event comprises a flow defined by a uniform resource locator (URL) pattern.

9. The method of claim 1, where the detected event comprises an anomaly defined by a specific condition in one or more fields in the semi-structured text message.
